(19) United States
(12) Patent Application Publication
(10) Pub. No.: US 2004/0113931 A1
(43) Pub. Date: Jun. 17, 2004

(54) Human-computer interfaces incorporating haptics and path-based interaction

(76) Inventor: Thomas G. Anderson, Albuquerque, NM (US)

Correspondence Address: V. Gerald Grafe, esq., P.O. Box 2689, Corrales, NM, 87048, US

(21) Appl. No.: 10/729,574

(22) Filed: Dec. 4, 2003

Related U.S. Application Data
(60) Provisional application No. 60/431,060, filed on Dec. 5, 2002.

(51) Int. Cl. G09G 5/00

(52) U.S. Cl. 345/701

(57) ABSTRACT

A method of providing an efficient interaction with a user of a human-computer interface. The method comprises establishing two paths: a device fundamental path and an object fundamental path. The two paths, which can comprise different geometric figures, are related by the interface in a defined correspondence. Motion by the user of an input device along the device fundamental path can be detected by the interface, and used to cause motion of an object in the computer application along the object fundamental path. The interface can also detect off-path motion of the input device. The interface, in some embodiments, can affect characteristics of the object or of other parts of the application responsive to such off-path motion. For example, the interface can change the angle or other property of an object responsive to off-path motion of the input device. The interface can also apply forces to an input device responsive to such off-path motion of the device. For example, the interface can apply force resisting off-path motion of the device, providing the user feedback. This feedback can guide the user to motion along the device fundamental path, and can allow the user to control an aspect (such as angle) of the application by control of the off-path force the user applies to the input device.

### CROSS REFERENCE TO RELATED APPLICATIONS

This application claims the benefit of U.S. Provisional Application 60/431,060, “Human-Computer Interfaces Incorporating Haptics,” filed on Dec. 5, 2002, incorporated herein by reference.

### BACKGROUND OF THE INVENTION

This invention relates to the field of haptic human-computer interfaces, specifically to methods and apparatuses making haptic interaction more efficient or more realistic.

Computing technology has seen a many-fold increase in capability in recent years. Processors work at ever higher rates; memories are ever larger and always faster; mass storage is larger and cheaper every year. Computers now are essential elements in many aspects of life, and are often used to present three-dimensional worlds to users, in everything from games to scientific visualization.

The interface between the user and the computer has not seen the same rate of change. Screen windows, keyboard, monitor, and mouse are the standard, and have seen little change since their introduction. Many computers are purchased with great study as to processor speed, memory size, and disk space. Often, little thought is given to the human-computer interface, although most of the user's experience with the computer will be dominated by the interface (rarely does a user spend significant time waiting for a computer to calculate, while every interaction must use the human-computer interface).

As computers continue to increase in capability, the human-computer interface becomes increasingly important. The effective bandwidth of communication with the user will not be sufficient using only the traditional mouse and keyboard for input and monitor and speakers for output. More capable interface support will be desired to accommodate more complex and demanding applications. For example, six degree of freedom input devices, force and tactile feedback devices, three dimensional sound, and stereo or holographic displays can improve the human-computer interface.

As these new interface capabilities become available, new interface methods are needed to fully utilize new modes of human-computer communication enabled. Specifically, new methods of interaction can use the additional human-computer communication paths to supplement or supplant conventional communication paths, freeing up traditional keyboard input and visual feedback bandwidth. The use of force feedback, or haptics, can be especially useful in allowing a user to feel parts of the interface, reducing the need for a user to visually manage interface characteristics that can be managed by feel. Users interfacing with non-computer tasks routinely exploit the combination of visual and haptic feedback (seeing one side of a task while feeling the other); bringing this sensory combination into human-computer interfaces can make such interfaces more efficient and more intuitive for the user. Accordingly, there is a need for new methods of human-computer interfacing that make appropriate use of haptic and visual feedback.

### SUMMARY OF THE INVENTION

The present invention comprises a method of providing an efficient interaction with a user of a human-computer interface. The method comprises establishing two paths: a device fundamental path and an object fundamental path. The two paths, which can comprise different geometric figures, are related by the interface in a defined correspondence. Motion by the user of an input device along the device fundamental path can be detected by the interface, and used to cause motion of an object in the computer application along the object fundamental path.

The interface can also detect off-path motion of the input device. The interface, in some embodiments, can affect characteristics of the object or of other parts of the application responsive to such off-path motion. For example, the interface can change the angle or other property of an object responsive to off-path motion of the input device.

The interface can also apply forces to an input device responsive to such off-path motion of the device. For example, the interface can apply force resisting off-path motion of the device, providing the user feedback. This feedback can guide the user to motion along the device fundamental path, and can allow the user to control an aspect (such as angle) of the application by control of the off-path force the user applies to the input device.

Advantages and novel features will become apparent to those skilled in the art upon examination of the following description or may be learned by practice of the invention. The objects and advantages of the invention may be realized and attained by means of the instrumentalities and combinations particularly pointed out in the appended claims.

### DESCRIPTION OF THE FIGURES

The accompanying drawings, which are incorporated into and form part of the specification, illustrate embodiments of the invention and, together with the description, serve to explain the principles of the invention.

FIG. 1 is a schematic representation of an input device and a corresponding object in an application.

FIG. 2 is a schematic representation of a device fundamental path and corresponding object fundamental path.

FIG. 3 is a schematic representation of a device fundamental path comprising a surface.

FIG. 4 is a schematic representation of an example device fundamental path and corresponding object fundamental path.

FIG. 5 is a schematic representation of a device fundamental path and a motion-initiation region.

FIG. 6 is a schematic representation of a device fundamental path initiated by a motion-initiation actuation.

FIG. 7 is a flow diagram of one mode of operation of an interface according to the present invention.

FIG. 8 is a flow diagram of one mode of operation of an interface according to the present invention.

FIGS. 9(a,b,c,d) comprise a schematic diagram of several steps in an interface according to the present invention applied to golf simulation.

FIGS. 10(a,b,c,d) comprise a schematic diagram of several steps in an interface according to the present invention applied to pool or billiards simulation

### DETAILED DESCRIPTION OF THE INVENTION

The present invention comprises methods and apparatuses related to communication with a user, with example applications in computer games. The present invention is amenable to use with 3 dimensional positional input devices with force feedback, though the present invention is useful with other input devices as well. Input devices with force feedback, or “haptic devices,” can provide user inputs in terms of three-dimensional position (i.e., X, Y & Z) and, sometimes, orientation (i.e., theta1, theta2 & theta3). The devices can provide three-dimensional forces. These forces can comprise 3 degrees-of-freedom (i.e., X, Y, & Z) and, sometimes, can also accommodate rotational forces (i.e., theta1, theta2 & theta3). The “range of motion” of an input device is the volume or area throughout which the input device can move, limited by, as examples, the geometry of the device or of an interface surface (such as a mouse pad). The range of motion can also be that portion of the device range of motion that can be efficiently used by the user.

The description herein assumes that a user of a human-computer interface controls a user input device, for example a haptic device such as discussed above. The input device is moveable by the user throughout a number of positions, the collection of which is termed the “range of motion” of the input device. The human-computer interface allows the user to interact with an application on the computer, for example a computer game. Objects and actions in the application can be communicated to the user in various manners, including as examples by visual display and by sound generation. A human-computer interface according to the present invention affords to the user an improved control of an object in the application.

Haptic interfaces can be connected with visual images. Realistic visual images are available from capture of real-world images and from computer animation. Realistic visual images, however, can comprise vary complex motion. A golf swing, for example, can involve many continuously changing angles and arcs as the player moves to effect the travel of the club. Each action, moreover, can be different from all others. For example, each golfer's swing can differ from that of other golfers, and even a single golfer can present different swings depending on the club and game situation. Providing haptic representations of such a large number of complex motions can be too costly for many applications.

The visual sensory path in humans, however, generally overrides the proprioceptive and kinesthic sensory paths. This means that the human perception of an environment is generally controlled by the visual information, with other information providing additional realism and additional information, and any conflicts resolved in favor of the visual information. A haptic interface can, therefore, provide a simplified haptic representation of a complex motion and still provide a user with a full sense of realism. In gaming applications, for example, a single simple haptic representation can be used in connection with many varied and complex visual representations. A single curved haptic path, for example, can be used as the haptic counterpart to realistic golf swings of different golfers in a variety of situations.

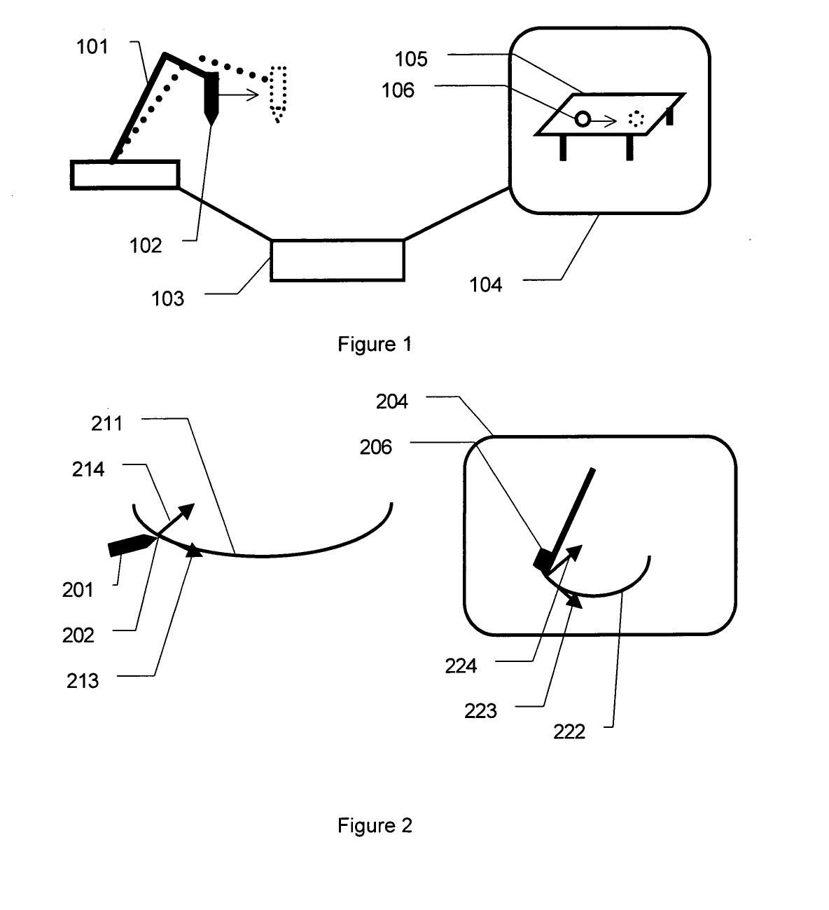

FIG. 1 is an illustration of a computer input device 101 in communication with a computer 103. The computer 103 controls a display 104. A user (not shown) of the system can control the input device 101, for example by moving a specific point 102 on the input device 101. Motion of the specific point 102 can be communicated to the computer 103, which can provide a human-computer interface that provides specific computer actions responsive to specific signals from the input device. The computer 103 can cause the display 104 to provide appropriate visual feedback to the user. As an example, the computer 103 can provide an application comprising a table 105 and an object 106 thereon. The table 105, object 106, and their relative positions can be communicated to the user via the display 104. The human-computer interface can allow the position of the object 106 in the application to change responsive to changes in position of the point 102 on the user input device 101. For example, the user can move the point 103 to the left, and human-computer interface can cause the representation of the object 106 to move to the left in the display 105. The above is intended as a simplified description; those skilled in the art will appreciate the invention's applicability to more complex applications and motions.

In some applications, the path desired for the object in the application can be different than the path desired for the user input device. For example, the path followed by the head of a golf club can be complex, and can be vary from golfer to golfer. A computer application that displays the path of a golf club might display motion that closely approximates the actual path followed, even mimicking the visual effect of different golfers' swings. Requiring the user to move the input device in a manner that exactly corresponds to the actual path can require overly difficult user control, and can result in decreased effectiveness of the human-computer interface.

The present invention provides an “object fundamental path,” which is a path in the application that the object is expected to follow (in some applications, the object must follow the object fundamental path, in others, the object can stray from the object fundamental path). The present invention also provides a “device fundamental path,” which is a path in the range of motion of the input device that has a defined correspondence to the object fundamental path. The description below generally discusses a single device path in correspondence with a single object path; the invention is also applicable with multiple device paths corresponding to a single object path (e.g., there are several ways to effect the desired object motion); with a single device path corresponding to multiple object paths (e.g., there are several objects that can be controlled with a with motion along a single defined path); and with multiple device paths each mapped to one or more object paths (e.g., there are multiple objects that can be controlled, each according to one or more device paths). The object and device paths can also depend on the state of the application (e.g., the object might move in one manner when the application is in a first state, and in a second manner when the application is in a second state).

FIG. 2 is an illustration of two example paths and their correspondence. An input device 201 allows a user to control the position of a point 202. The point 202 can move along a device fundamental path 211 in the device's range of motion. Motion of the point 202 can viewed as comprising a component 213 along the device fundamental path 211 and a component 214 not along the device fundamental path 211. The human-computer interface can provide a correspondence between motion of the point 202 and motion of an object 206 in the application, shown in the figure on a display 204 controlled by the interface. The interface can define an object fundamental path 222 within the application. Motion of the point 202 along the device fundamental path 213 can be mapped by the interface to motion of the object 206 along the object fundamental path 223. Motion of the point 202 not along the device fundamental path 214 can be accommodated as described below. Note that the correspondence between the two paths can be established by the interface, so that, for example, the object fundamental path can comprise a complex curve, well-suited for realistic display, while the device fundamental path can comprise a simple parabola, well-suited for efficient computer processing and efficient user control.

The interface can accommodate various effects of motion of the device not along the device fundamental path. As an example, the interface can apply a force to the input device, resisting off-path motion. The user can therefore be constrained to follow the device path, allowing the user to effectively control an object along a complex path by simply following the leading of the forces applied by the interface. As another example, the interface can change characteristics of the object in the application responsive to motion not along the device path, for example changing the angle of a golf club head. The user can therefore control an object along a complex path, and control characteristics of the object by off-path motion. As another example, the interface can change how an object interacts with other parts of the application based on off-path motion. The interface can also change the visual representation of the object according to off-path motion, for example by changing the size, shape, or color of the visual representation to indicate to the user off-path motion.

The interface can also supply forces to the input device responsive to the object's motion in the application. For example, a portion of the object path can encounter various situations (e.g., a car encountering a rough road or an obstacle, a golf club encountering sand or a ball). The interface can apply forces to the input device to communicate to the user such situations. For example, the interface can apply a friction force resisting on-path motion of the input device when the object encounters a situation that resists its on-path motion in the application. The interface can also apply forces to the input device to reflect interactions of the object with the application. For example, the interface can apply forces to the input device to provide a feel for the effects of wind blowing in the application, or of other objects in the application striking the object. The interface can also apply forces to the device that oppose motion of the device beyond boundaries of the device path, giving the user a force-based sense of the end of the path and lessening the possibility of physical damage to the input device from forceful movement at the extremes of its range of motion. For example, the interface can apply a force opposing motion of the input device at the end of a path mapped to a golf swing. The interface can also apply forces to the device to provide the user a force-based sense of motion of the object in the application. For example, the interface can apply forces to provide the user with a sense of inertia and momentum of the object as it moves in the application. The speed of the motion of the object along the object path can also affect the object's interaction with other parts of the application. For example, a quickly moving pool cue object can cause balls in the application to move faster than a slowly moving pool cue.

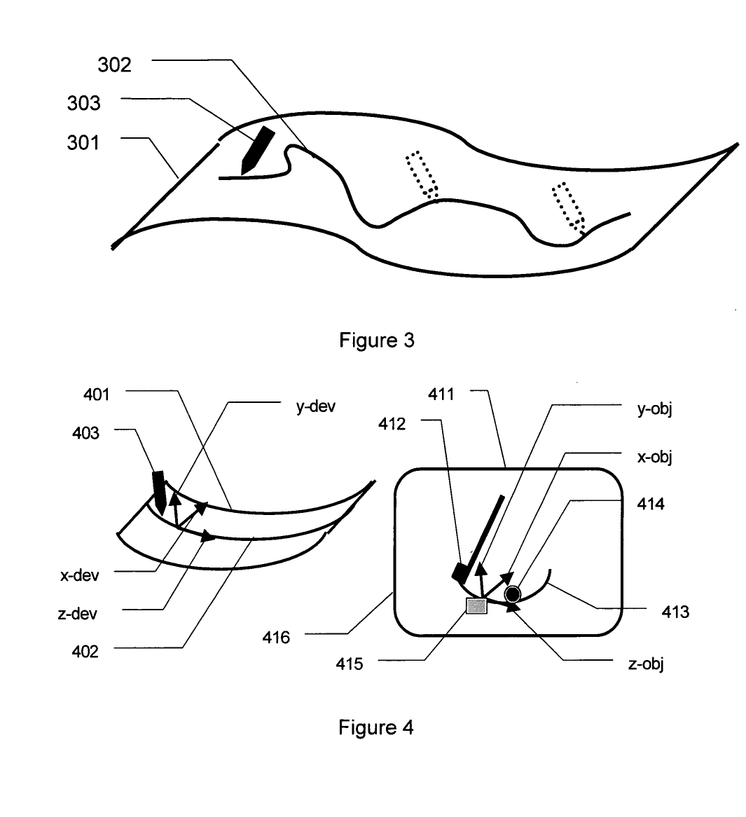

Each path can comprise any shape suitable for the application or input device. FIG. 2 illustrated a two-dimensional path; three-dimensional paths can also be accommodated. FIG. 3 is an illustration of a path defined to be a surface 301. Motion “along the path” with such a path can be any motion in the surface. An example path 302 that can be traveled by an input device 303 is shown. The interface can apply forces to the input device resisting any motion normal to the surface, keeping the input device in the surface 301. The surface 301 can correspond to a object path that is also a surface, in which case motion of the input device within the device surface can correspond to motion of the object within the object surface. The surface can also correspond to an object path that is a curve, in which case motion within the device surface can be ignored, or can be used to control another aspect of the application. The correspondence can comprise various combinations; for example part of the device path can comprise a surface while part can comprise a curve to allow specific object behaviors to be accommodated.

The interface can also use the correspondence between the paths to help make efficient use of the input device's range of motion. As an example, the interface can allow a transition to a path-based interaction only when the input device is in a configuration such that allowable or expected motion in the path-based interaction will be within the range of motion of the input device. As another example, the interface can map the current position of the input device to a place on the device path such that allowable or expected motion in the path-based interaction will be within the range of motion of the input device (e.g., map to the middle of a parabola if the device is near the middle of the range of motion; map to an end if the device is near a boundary of its range of motion). As another example, the interface can apply forces to the input device to move it to a place in its range of motion when the path-based interaction is begun, such that subsequent motion will be within the range of motion of the input device. In some applications, the interface can apply such forces constantly to provide the user with a force-based sense of the appropriate place to begin the path-based interaction (e.g., continuously pulling the user to a point at which an object in the application can be grasped and manipulated according to a path-based interaction).

FIG. 4 is a schematic representation of an interface according to the present invention adapted for use in a golf game. A device fundamental path comprises a surface 401, with a preferred path comprising a curve 402 lying on the surface 401. A user can control an input device 403, with components of motion along dimensions labeled for convenience as z-dev along the curve 402, x-dev orthogonal to the curve 402 and in the surface 401, and y-dev normal to the surface 401. A corresponding object, the head 412 of a golf club 411 in the application, can be represented to the user via a display 416. An object fundamental path is defined as a curve 413 in the application space and, as discussed above, can be the same or different shape as the curve 402 of the device fundamental path. Motion of the object 412 can be labeled for convenience as z-obj along the curve 413, x-obj and y-obj orthogonal to the curve 413 and to each other. Sand 415 and a golf ball 414 are also represented in the application at defined locations relative to the object fundamental path 413.

In operation, the interface can apply a large force opposing any device motion component along the y dimension, keeping the input device motion along the surface. Any y-dev motion in opposition to the y-dev force can be ignored for determining the actions in the application. The interface can apply a smaller force opposing any motion component along the x dimension, encouraging the user to keep the input device along the curve 402 but allowing off-curve (but still in surface) motion. Any x-dev motion in opposition to the x-dev force can be used by the interface to establish a tilt for the club head object 412, with the tilt value when the object 412 contacts the ball 414 used to determine a resulting trajectory of the ball. The interface can map device motion along z-dev to object motion along z-obj, allowing the user to control the golf club head 412 along its object path by controlling the input device along its path.

The interface can also apply resistive forces opposing z-dev motion of the input device 403 when the object 412 moves to a position within the sand 415. It can also apply a force impulse when the object 412 moves to a position that indicates contact with the ball 414. The history of the input 403 device (e.g., change over time, or speed), and correspondingly of the object 412, can be used to determine the impulse given to the ball 414 and the ball's resultant trajectory.

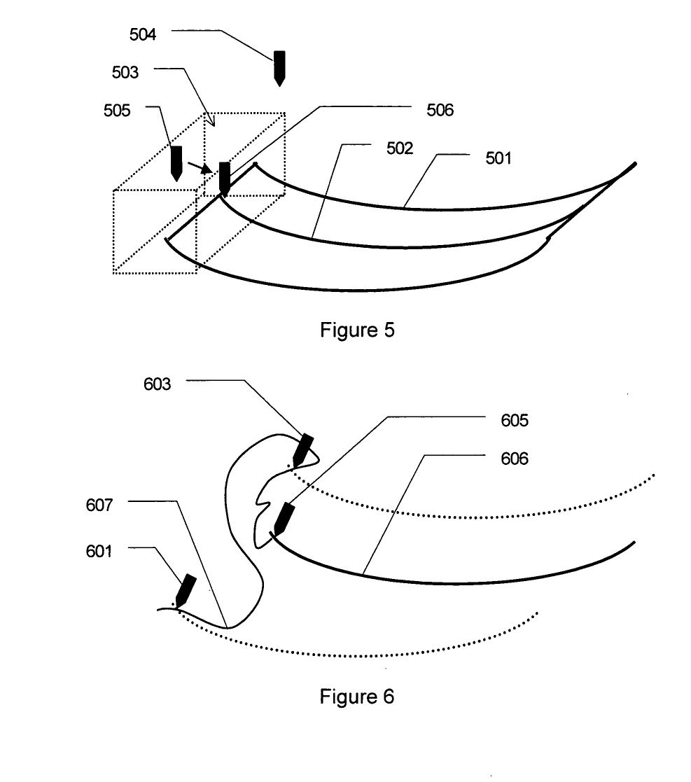

If the interface generally allows freedom of motion of the input device, then it can be important that the user be able to control and sense when the input device is on a device fundamental path. FIG. 5 is a schematic representation of a mapping of an input device's range of motion that allows such control. A device fundamental path comprises a surface 501 and curve 502, for example, like that discussed above. A portion of the range of motion of the input device is defined as a motion-initiation region 503. When the input device 504 is outside the motion-initiation region 503, then the interface provides a user interaction independent of the device fundamental path. When the user positions the input device 505 inside the motion-initiation region 503, the interface provides an interaction according to the device fundamental path 501. For example, the interface can apply forces to the input device 505 to urge it to a position 506 on the device fundamental path 502 (or “snap” to the path).

FIG. 6 is a schematic representation of another method allowing the user to reliably control entry into the fundamental path mode of interaction. The user is provided a switch which, when actuated, causes the interface to provide an interaction according to a device fundamental path. The switch can comprise, as examples, a button to press or release, a voice command to speak, a key to press or release, a defined motion of the input device (e.g., a tight circle motion) or any of many indication means known to those skilled in the art. The interface allows the user to move the input device, for example from a point 601 to another point 603. As long as the switch is not actuated, the interface does not provide the path interaction. In the figure, the user actuates the switch when the input device is at a third point 605. The interface then provides interaction according to a device fundamental path, shown in the figure comprising a curve 606. In the figure, the path begins at the point where the switch was actuated. The path can have an intermediate point where the switch was actuated, or the interface can apply forces to move the input device to a point in its range of motion that corresponds to a defined point on the device fundamental path. This can be useful if, for example, the device is in a configuration when the switch is actuated that does not accommodate the desired motion along the device fundamental path. The methods of FIGS. 5 and 6 can be combined, and the switch actuation only effective when the input device is within a defined region of its range of motion (or, an object corresponding to the input device is within a defined region in the application).

The interaction according to the fundamental path can also comprise a re-mapping of the range of motion of the input device. For example, the user can move the input device in a large portion of its range of motion to move around in the application space. A small portion of the application space can correspond to the path of an object whose interaction is according to paths as described above. Initiating a path-based interaction can remap the input device's range of motion so that a large portion of the range of motion corresponds to the device path, allowing the user to use the larger range of motion to interact with the object than would have been available with a direct, unchanged correspondence between the input device and the application space. As a specific example, consider a basketball game, where the user is trying to throw the ball to a specific target (e.g., a basket or another player). For realistic visual communication, the target can be presented as small portion of the visible space. That same small portion, when translated into the range of motion of a haptic interaction device, can require undesirable or unachievable precision motion. The interface can recognize that the user is in contact with the ball. In that interface state, a large portion of the range of motion of the user can be mapped to the small portion of the application space around the intended target. Thus, the user can use coarser motion, better suited to the hand and haptic interaction device, to accomplish precise motion in the game. The path correspondence can scale angular or linear relationships to help the user to reach the desired goal. In the basketball example, the interface can transform small motion by the user to long motion in the game (to allow short throws to reach distant targets) and can transform large angles of the user motion to small angles in the game (to allow precise direction control for on-target throws).

The response of the interface to off-path motion can also contribute to an effective user interaction. For example, it can be difficult for a user to accurately manipulate an input device to control a computer game; that can be part of the challenge, but can be frustrating for beginners. Conventional interfaces make all user input trivial, and rely on decisions and timing for challenge. Haptic interaction devices, and non-haptic interaction devices with multiple degrees of freedom, can allow more realistic, and more challenging, input. However, the interface must accommodate varying user skill levels to present the desired challenge.

The interface can apply forces resisting off-path motion to assist the user in accurately moving the input device. The magnitude of the guiding forces can be varied according to the desired level of assistance; for example, the interface can provide a beginner mode where large guiding forces are applied even for small off-path motion, and an expert mode where smaller (or no) guiding forces are applied. As another example, the interface can apply forces that encourage off-axis motion to increase the difficulty by perturbing the user control of the input device.

Example Interface Implementation

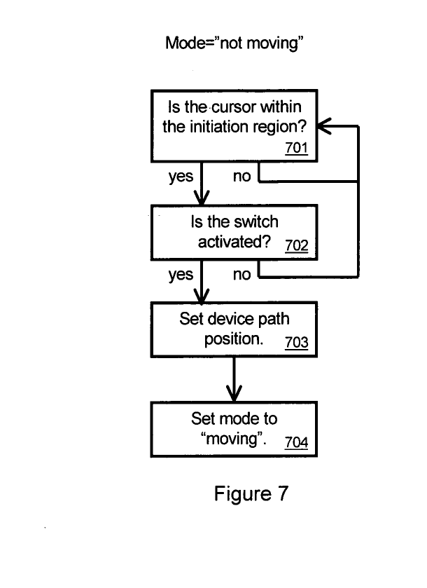

FIG. 7 is a flow diagram of one mode of operation of an example interface according to the present invention. The mode is labeled “not moving,” indicating that the user is not moving the input device along a device path in correspondence with an object path. The interface determines whether the user has positioned a cursor within a motion initiation region 701. Once the cursor is in the motion initiation region, then the interface determines whether a switch has been activated 702. Once the switch has been activated while the cursor is in the motion initiation region, the interface establishes a position of the input device along the device path 703, and sets the interface mode to “moving.”

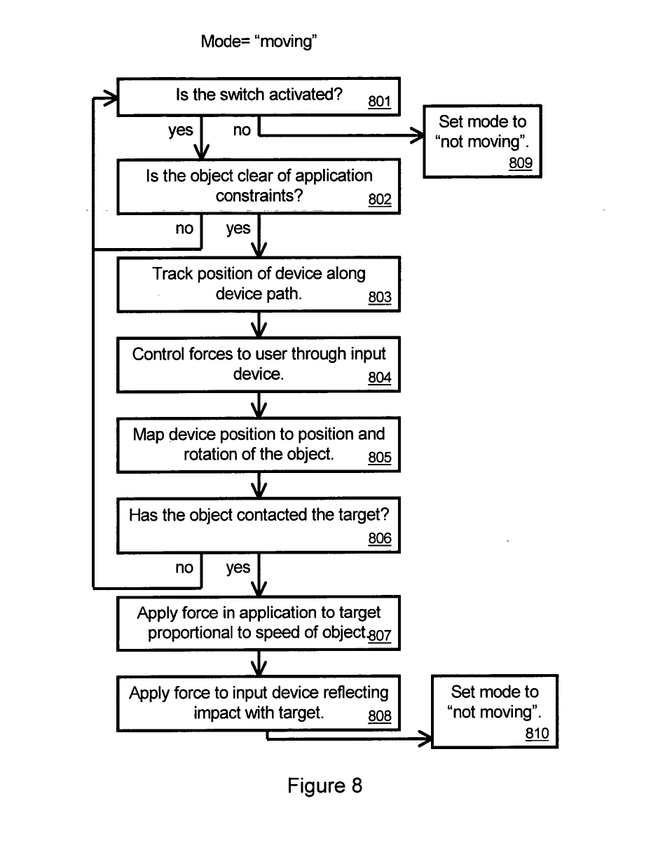

FIG. 8 is a flow diagram of another mode of operation of an example interface according to the present invention. The mode is labeled “moving,” indicating that the user is moving the input device along a device path in correspondence with an object path. The interface verifies that the switch is activated 801. If not, then the interface sets the mode to “not moving,” as in FIG. 7. If so, then the interface determines whether the object in the application is clear of application constraints 803. Constraints can be, for example, relationships between the object and other parts of the application that are inconsistent with the intended subsequent motion (e.g., a golf club that is already past the ball when the switch is actuated). If the object is not clear of application constraints, then the interface waits until the switch is activated and the device is clear. Once that condition is attained, then the interface tracks the position of the input device along a device path 803. The interface applies control forces to the user to reflect the desired device path interaction 804, such as the example force relationships described above. The interface maps the device position to the position and characteristics (e.g., rotation) of the object 805. The interface determines whether the object has moved to a position along the object path that indicates an interaction event, for example whether the object has contacted a target 806. If it has, then the interface applies an appropriate simulated force to the target, e.g., a force proportional to the speed of the object prior to impact 807. The interface can also apply a force to the input device to communicate the impact of the object with the target to the user via the input device 808. The interface can then set the interface mode to “not moving” and wait for another initiation of a path-based interaction 810.

Golf Interface Example

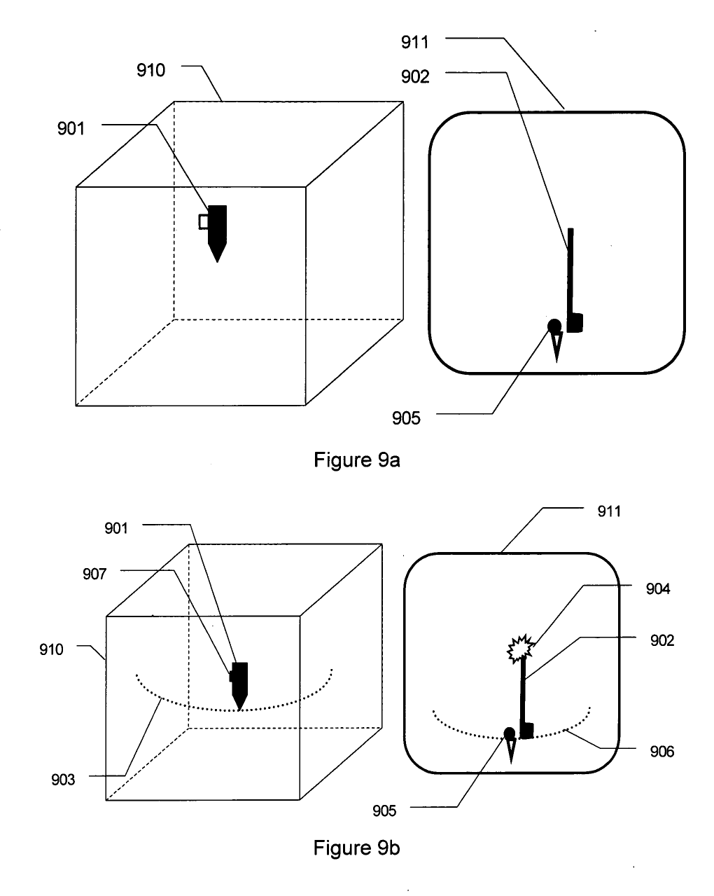

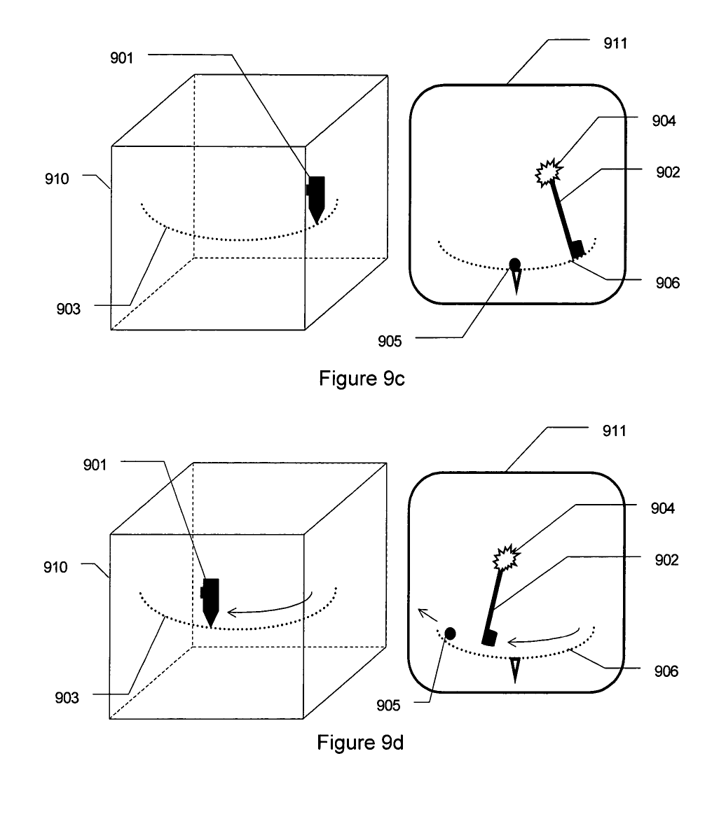

FIGS. 9(a,b,c,d) comprise a schematic diagram of several steps in an interface according to the present invention applied to golf simulation. In FIG. 9a, the user can manipulate an input device 901 over a range of motion 910 thereof, but has not yet initiated a path-based interaction to control a golf club object 902 in the application. The application comprises a display 911 of objects in the application such as a golf club object 902 and a golf ball object 905.

In FIG. 9b, the user has initiated a path-based interaction by moving the input device 901 to an appropriate region of its range of motion and pressing a switch 907. The interface has established a device path 903 in the range of motion 910 in correspondence with an object path 906 for the golf club object 902 in the application. The interface has also added a visual indication 904 of the establishment of the path-based interaction to the display of the object in the application.

In FIG. 9c, the user has moved the input device 901 to the right along the device path 903, and the interface has moved the golf club object 902 along the corresponding object path 906. The interface can apply forces to the input device 901 to encourage the user motion of the input device 901 to remain along the device path 903. The interface can establish a tilt or angle of the face of the golf club object 902 in the application based on motion of the input device 901 off the device path 903. The interface can also apply forces to the input device 901 to simulate other forces that might be useful or informative from the application, for example forces to reflect simulated wind or other objects in the application. The golf club object 902 can be modeled by the interface as a weight attached to a point by a spring; the interface can apply forces to the input device 901 that are determined according to the weight-spring system. This can provide the user with realistic force sensation of motion without incurring problematic force profiles or interface instability.

In FIG. 9d, the user has moved the device 901 to the left along the device path 903, past the point where the object on the corresponding object path would contact the golf ball object 905 in the application. The interface has moved the golf club object 902 along the corresponding object path in the application, and has changed the display of the golf ball object 905 simulating the impact of the golf club object 902 with the golf ball 905. The simulated impact can reflect the speed of the golf club object 902 (which itself reflects the speed of the input device 901 due to the correspondence between the input device path 903 and the golf club object path 906). The simulated impact can also reflect directionality from a tilt or angle of the club face established from off-path motion of the input device 901.

Pool Interface Example

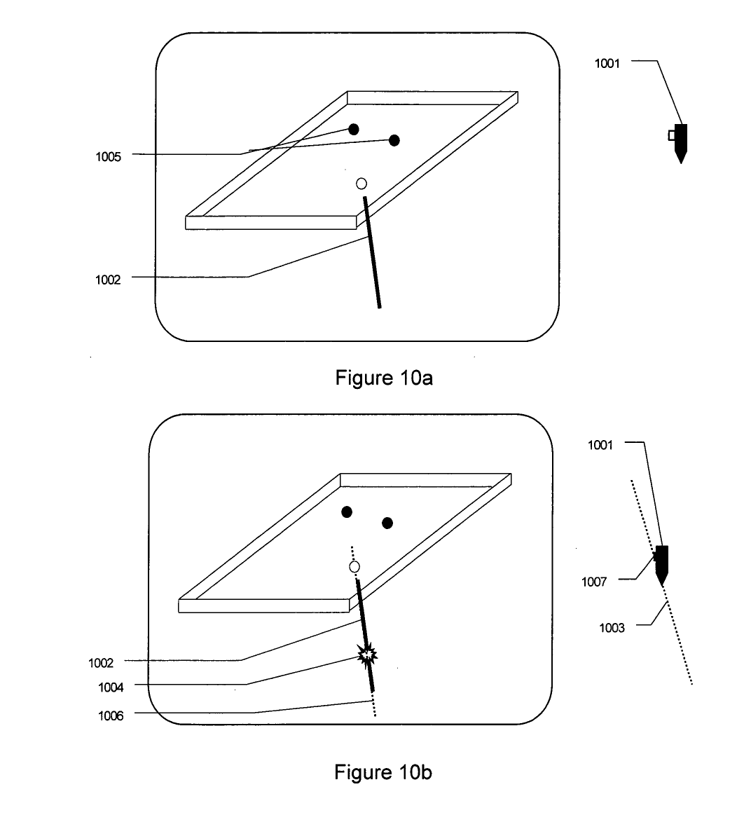

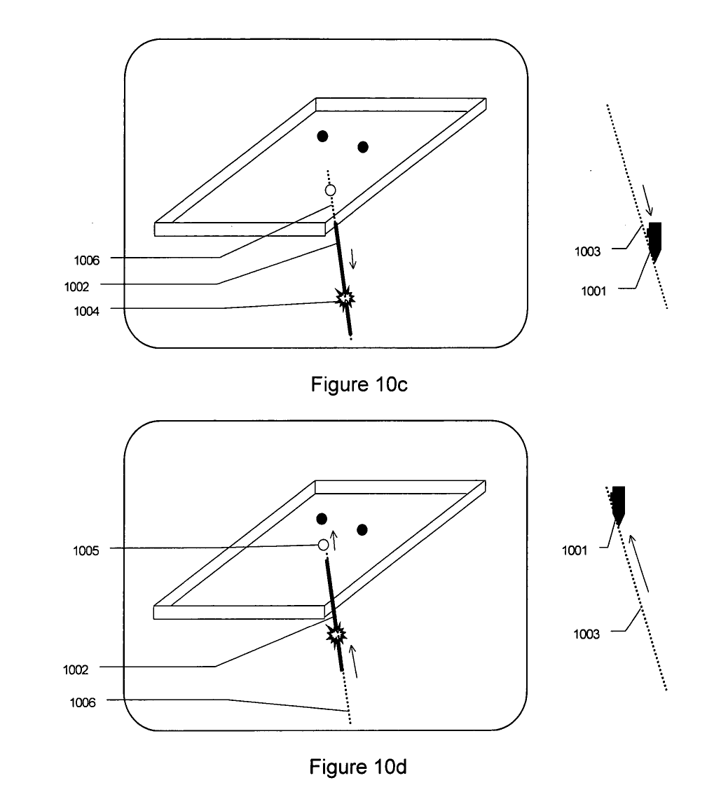

FIGS. 10(a,b,c,d) comprise a schematic diagram of several steps in an interface according to the present invention applied to pool or billiards simulation. In FIG. 10a, the user can manipulate an input device 1001 over a range of motion thereof, but has not yet initiated a path-based interaction to control a pool cue club object 1002 in the application. The application comprises a display 1011 of objects in the application such as a pool cue object 1002 and a plurality of pool ball objects 1005.

In FIG. 10b, the user has initiated a path-based interaction by moving the input device 1001 to an appropriate region of its range of motion and pressing a switch 1007. The interface has established a device path 1003 in the range of motion in correspondence with an object path 1006 for the pool cue object 1002 in the application. The interface has also added a visual indication 1004 of the establishment of the path-based interaction to the display of the object in the application.

In FIG. 10c, the user has moved the input device 1001 toward the user (roughly downward in the figure) along the device path 1003, and the interface has moved the pool cue object 1001 along the corresponding object path 1006. The interface can apply forces to the input device 1001 to encourage the user motion of the input device 1001 to remain along the device path 1003. The interface can establish the orientation of the pool cue object 1002 in the application, and therefore the direction of the resulting shot, based on motion of the input device 1001 off the device path 1003. The interface can also apply forces to the input device 1001 to simulate other forces that might be useful or informative from the application, for example forces to reflect simulated friction or contact with the table. The pool cue object 1002 can be modeled by the interface as a weight attached to a point by a spring; the interface can apply forces to the input device 1001 that are determined according to the weight-spring system. This can provide the user with realistic force sensation of motion without incurring problematic force profiles or interface instability.

In FIG. 10d, the user has moved the device 1001 away from the user (roughly upward in the figure) along the device path 1003, past the point where the tip of the pool cue object 1002 on the corresponding object path would contact the pool ball object 1005 in the application. The interface has moved the pool cue object 1002 along the corresponding object path in the application, and has changed the display of the pool ball object 1005 simulating the impact of the pool cue object 1002 with the pool ball 1005. The simulated impact can reflect the speed of the pool cue object 1002 (which itself reflects the speed of the input device 1001 due to the correspondence between the input device path 1003 and the pool cue object path 1006). The simulated impact can also reflect directionality of the pool cue established from off-path motion of the input device 1001.

The particular sizes and equipment discussed above are cited merely to illustrate particular embodiments of the invention. It is contemplated that the use of the invention may involve components having different sizes and characteristics. It is intended that the scope of the invention be defined by the claims appended hereto.

We claim:

1. In a human-computer interface, a method of allowing a user of a haptic input device to affect the motion of an object in a computer application, comprising:
a) Establishing an object fundamental path representing a path of motion of the object in the computer application;
b) Establishing a device fundamental path in correspondence with the object fundamental path;
c) Detecting motion of the input device;
d) Moving the object in the computer application along the object fundamental path responsive to a component of input device motion along the device fundamental path; and
e) Applying a force to the input device responsive to a component of input device motion not along the device fundamental path.

2. A method as in claim 1, wherein the force resists motion of the input device not along the device fundamental path.

3. A method as in claim 1, further comprising applying a force to the input device responsive to interaction of the object with the application.

4. A method as in claim 1, further comprising applying forces to the input device corresponding to motion of the object in the application, wherein the forces provide a perception of momentum and inertia of the input device corresponding to momentum and inertia of the object in the application.

5. A method as in claim 1, wherein the application comprises a plurality of states, and wherein the object fundamental path is dependent on the state of the application.

6. A method as in claim 1, wherein the application comprises a plurality of states, and wherein the device fundamental path is dependent on the state of the application.

7. A method as in claim 1, wherein the object interacts with the application, and wherein the interaction of the object with the application is dependent on the speed of the object along the object fundamental path.

8. A method as in claim 1, further displaying a visual representation of the object to the user.

9. A method as in claim 8, wherein the visual representation when the device is on the device fundamental path is perceptively different from the visual representation when the device is not on the device fundamental path.

10. A method as in claim 1, further comprising:
a) Establishing a second object fundamental path representing a path of motion of a second object in the computer application;
b) Establishing a second device fundamental path in correspondence with the second object fundamental path;
c) Detecting motion of the input device;
d) Determining if either device fundamental path is active, and if so, then
e) Moving the object in the computer application along the active object fundamental path responsive to a component of input device motion along the active device fundamental path; and
f) Applying a force to the input device responsive to a component of input device motion not along the active device fundamental path.

11. A method as in claim 1, wherein the object comprises two representations, a visual representation that is used in a display to provide visual feedback to the user, and an interaction representation that is used with the input device to provide force feedback to the user.

12. A method as in claim 2, wherein the force has a first magnitude for a first position of the input device a first distance from the device fundamental path, and a second, larger magnitude for a second position of the input device a second, larger distance from the device fundamental path.

13. A method as in claim 1, further comprising applying a force along the device fundamental path opposing motion of the input device beyond an end of the device fundamental path.

14. A method as in claim 1, further comprising applying a force to the input device to urge the input device to a starting region of the range of motion of the haptic input device.

15. A method as in claim 1, wherein the device fundamental path has a different shape than the object fundamental path.

16. A method as in claim 1, wherein the device fundamental path defines a curve in three-dimensions.

17. A method as in claim 16, wherein the device fundamental path defines a curve in two-dimensions.

18. A method as in claim 1, wherein the device fundamental path defines a surface in three-dimensions.

19. A method as in claim 1, wherein a characteristic of the object in the application is responsive to motion of the input device off the device fundamental path.

20. A method as in claim 1, wherein the force resists motion of the input device off the device fundamental path along a first dimension, and wherein a characteristic of the object in the application is responsive to motion of the input device off the device fundamental path along a second dimension different from the first dimension.

21. A method as in claim 1, wherein the magnitude of the force is partially dependent on the position of the object along the object fundamental path.

22. A method as in claim 1, wherein the magnitude of the force is partially dependent on interaction of the object with the application.

23. A method as in claim 1, wherein the magnitude of the force is partially dependent on a user-assistance parameter of the interface.

24. A method as in claim 23, wherein the user-assistance parameter is established by a measure of the user's proficiency in manipulating the input device.

25. A method as in claim 1, additionally comprising:
a) Defining a motion-initiation region comprising a portion of the input device range of motion;
b) Determining when the input device is within the motion-initiation region; and
c) When the input device is within the motion-initiation region, applying a force to the input device urging the input device to the device fundamental path.

26. A method as in claim 1, wherein establishing a device fundamental path comprises:
a) Determining when the user supplies a motion-initiation signal; and then
b) Establishing a device fundamental path according to a defined device path and the position of a cursor controlled by the user when the motion-initiation signal was supplied.

27. A method as in claim 26, wherein the motion-initiation signal comprises motion of the cursor to a defined range of the cursor's range of motion.

28. A method as in claim 26, wherein the motion-initiation signal comprises a switch actuated by the user.

29. A method as in claim 27, wherein the motion-initiation signal further comprises detection of the position of the cursor in a defined range of the cursor's range of motion when the switch is actuated.

30. A method as in claim 26, wherein the motion-initiation signal comprises motion of the input device having defined characteristics.

31. A method as in claim 1, wherein:
a) The computer application comprises a golf simulation;
b) The object comprises a golf club; and
c) The object fundamental path comprises a path suited for perception of the swing of a golf club.

32. A method as in claim 1, wherein:
a) The computer application comprises a pool simulation;
b) The object comprises a pool cue; and
c) The object fundamental path comprises a path suited for perception of the motion of a pool cue.

33. A human-computer interface, comprising:
a) A haptic input device;
b) A means for detecting motion of the input device;
c) A means for displaying an object whose position along an object fundamental path is responsive to motion of the input device along a device fundamental path;
d) A means for applying a force to the input device responsive to motion of the input device.
